(19) United States
(12) Patent Application Publication
(10) Pub. No.: US 2007/0223351 A1
(43) Pub. Date: Sep. 27, 2007

(54) METHOD FOR PROCESSING SIGNAL IN A DISK DRIVE

(76) Inventors: Ping-Hsiu Chen, Guishan (TW); Chao-Jung Chen, Guishan (TW); Yi-Long Hsiao, Guishan (TW)

Correspondence Address: G. LINK CO., LTD., 3550 BELL ROAD, MINOOKA, IL, 60447, US

(21) Appl. No.: 11/537,653

(22) Filed: Oct. 1, 2006

(30) Foreign Application Priority Data
Mar. 21, 2006 (TW) 095109818

(51) Int. Cl. G11B 7/00

(52) U.S. Cl. 369/124.11; 369/47.28; 369/53.37

(57) ABSTRACT

A method for processing signals in a disk drive is provided. In the provided method, an RF signal is read at a predetermined highest reading speed, whose amplitude is adjusted with a gain. Then the level of the RF signal is adjusted by an equalizer with a predetermined parameter module. The RF signal is output if it could be read correctly. If failing to be read correctly, the amplitude of the RF signal to be read is checked. If the amplitude of the RF signal is not within a predetermined range, the gain is adjusted and then the step of reading the RF signal is re-proceeded and the procedures thereof are repeated. A further parameter module is applied by the equalizer if the amplitude of the RF signal is within the predetermined range. The procedures of the provided method are repeated after the reading speed of the disk drive is reduced if all of the parameter modules are applied. Otherwise, the method returns to the step of reading the RF signal and the procedures thereof are repeated until a proper parameter module is found out.

### FIELD OF THE INVENTION

The present invention relates to a method for processing signals in a disk drive, and more particularly to a method for processing signals whereby radio frequency (RF) signals read from an optical disk can be equalized and adjusted.

### BACKGROUND OF THE INVENTION

The operation of an optical disk drive involves reading data of high density from an optical disk which is rotating at a high speed, thereby producing a weak radio frequency (RF) signal. The procedures for processing the produced RF signal to obtain a correct signal are critical for the following signal process, which may directly affect the performance of the digital signal processor (DSP). A poor signal may cause an incorrect data reading, resulting in a failure play of the optical disk.

With reference to FIG. 1, which is the flowchart of the method for processing the RF signal in a conventional optical disk drive according to the prior art are shown therein. First, in step 10, the data stored on an optical disk rotating at a high speed is read by the conventional optical disk drive, and thereby an RF signal is produced. The produced RF signal is amplified by an automatic gain control (AGC) in step 11, in which the gain of the AGC is dynamically adjusted correspondingly to the desired amplitude of the RF signal, so that the amplitude of the RF signal can be output as desired therefrom. Subsequently, in step 12, the level of the RF signal is adjusted by an equalizer with a parameter module, so as to produce a superior RF signal for being input to a DSP. Typically, it adopts the same parameter module in the conventional optical disk drive with respect to the optical disk of a similar kind. The RF signal input to the DSP is decoded into a digital signal in step 13 for being output in step 14. If the RF signal fails to be decoded into a digital signal, the reading speed of the optical disk drive would be reduced in step 15, so as to lower the rotating speed of the optical disk, so that a better RF signal for being correctly decoded is readable therefrom.

Nevertheless, the AGC has a limited function of adjusting the gain. If the amplitude of the RF signal to be read is too large or too small, the AGC will fail to adjust the amplitude of the RF signal by means of automatic gain adjustment, which may affect the decoding process of DSP. In order to read out a better RF signal, the reading speed of the optical disk drive will be reduced accordingly. In this case, the time taken to read the data on the optical disk would be increased and the performance of the optical disk drive would be correspondingly reduced. Furthermore, since the conventional optical disk drive adopts an equalizer with the same parameter module to adjust the level of the RF signal with respect to optical disks of the same kind, the equalizer may have a limited coverage in adjusting the RF signal, which results in a poor RF signal in the cases of reading an optical disk having an over-high or over-low asymmetry and an optical disk which is severely jittering. The decoding process of DSP is hence affected, and the reading speed of the optical disk drive would be accordingly reduced to obtain a better RF signal, which decreases the whole performance of the disk drive. Therefore, it still needs lot of efforts in improving the RF signal processing in the conventional optical disk drive.

### SUMMARY OF THE INVENTION

It is one aspect of the present invention to provide a method for signal processing in an optical disk drive, which relates to an automatic switch among a plurality of predetermined parameter modules of an equalizer, so that a better RF signal could be obtained and thus the reading ability of the optical disk drive is improved.

It is another aspect of the present invention to provide a method for signal processing in an optical disk drive, wherein the output signal is pre-checked and adjusted through adjusting an automatic gain control, so as to prevent the reading ability of the optical disk drive from being affected by a poor RF signal.

It is a further aspect of the present invention to provide a method for signal processing in an optical disk drive, wherein the adjustment of automatic gain control and the switch among the parameter modules of the equalizer are performed at the highest reading speed which is gradually reduced upon failing in signal reading, so as to enhance the performance of the optical disk drive.

For achieving the mentioned aspects, a method for processing signals in a disk drive is provided in the present invention. In the provided method, an RF signal is read at a predetermined highest reading speed at the start, whose amplitude is adjusted with a gain. Then the level of the RF signal is adjusted by an equalizer with a predetermined parameter module. The RF signal is output if it could be read correctly. If failing to be read correctly, the amplitude of the RF signal to be read is checked. The gain is adjusted, then the step of reading RF signal is proceeded again and the following steps are repeated if the amplitude of the RF signal is not within a predetermined range. If the amplitude of the RF signal is within the predetermined range, a further parameter module is applied by the equalizer. The procedures of the provided method are repeated after the reading speed of the disk drive is reduced and the parameter module is zero-set if all of the parameter modules are applied.

Otherwise, the method returns to the step of reading the RF signal and the procedures thereof are repeated until a proper parameter module is found out.

### BRIEF DESCRIPTION OF THE DRAWINGS

The foregoing and other features and advantages of the present invention will be more clearly understood through the following descriptions with reference to the drawings, wherein:

FIG. 1 is a flow chart showing the method for processing the RF signal in a conventional optical disk drive according to the prior art; and

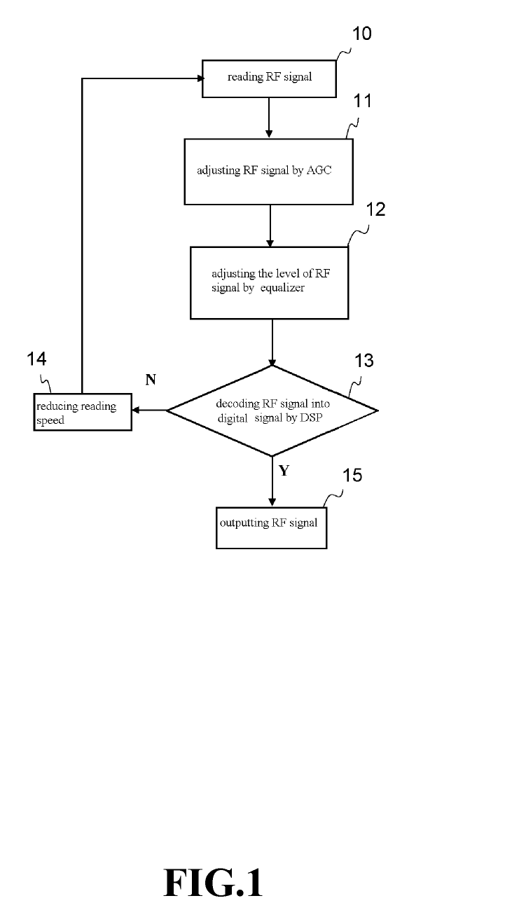

FIG. 2 is a flow chart showing the method for processing the RF signal in an optical disk drive according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

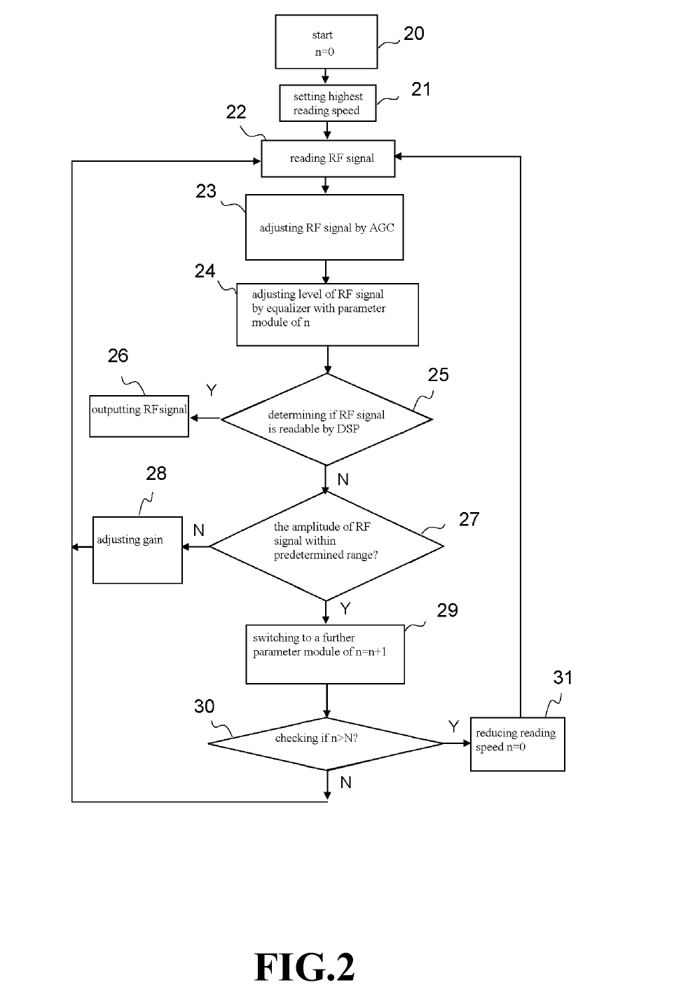

With reference to FIG. 2, the method for processing the RF signal in a conventional optical disk drive according to an embodiment of the present invention is shown therein. The method aims to the RF signals read from an optical disk. Before the digital signal processor (DSP) fails to read the RF signals and the reading speed is accordingly reduced, the optical disk drive can be kept operating at the highest reading speed, and in such case the automatic gain control (AGC) as well as the equalizer are adjusted, so as to eliminate the factors causing a poor RF signal in such a way that the optical disk would be read by the optical disk drive at the highest reading speed.

Under a normal operating condition, the gain is dynamically adjusted by the AGC, and therewith the amplitude of an RF signal read from the optical disk by the disk drive could be amplified or reduced to a predetermined range. While the amplitude of the RF signal read from the optical disk is over-large or over-small, exceeding the range that is dynamically adjusted by the AGC, the RF signal could not be scaled to a predetermined amplitude with the gain adjusted thereby. In this case, the output RF signal would be irregular, failing to be correctly read by the DSP According to the present invention, the RF signal output from the AGC would be pre-checked for determining if any irregularity exists therein. If the output signal is irregular, the gain for adjusting the RF signal would be regulated accordingly, and the RF signal would be adjusted therewith, so that an RF signal with predetermined amplitude can be output from the AGC and then input to the equalizer. Accordingly, the factors causing a poor RF signal could be eliminated by the present invention, so as to prevent the reading speed of the optical disk drive from being reduced.

Furthermore, since the equalizer is always provided with only one parameter module which is predetermined for a normal operating condition with respect to the optical disk of the same kind, so as to adjust the level of the RF signal read therefrom. With respect to the optical disks which are of a relatively poor quality, of an over-high or over-low asymmetry, and severely jittering, the equalizer needs to be set with further one or more parameter modules therefor, so as to adjust the level of the RF signal read from the optical disk in the respective cases. Nevertheless, such parameter modules, which are respectively determined with respect to the mentioned irregular cases, are not necessarily the optimal ones for the normal disks. Thus it is difficult to use the equalizer with only one parameter module to correspond to the whole above-mentioned conditions. According to the present invention, for solving such issue, one parameter module is predetermined with respect to the same kind of optical disk under a normal operating condition, and therewith the level of the RF signal read from the same kind of optical disk is adjusted, while the further parameter modules with respect to the irregular optical disks would be respectively switched if the DSP fails in reading the RF signal, so as to find out a proper one to be used. Accordingly, the level of the RF signal is adjusted with the proper parameter module, so that it is not necessary to reduce the reading speed of the optical disk drive, and thus the best performance thereof could be maintained.

The detailed steps of the method for signal processing in an optical disk drive according to the embodiment of the present invention are illustrated as follows:

In step 20, the signal processing in the optical disk drive is initialized and the counting value n is zero-set.

In step 21, when the optical disk drive is initially operating, the optical disk is rotated at a highest speed, so as to increase the efficiency in reading the optical disk.

In step 22, the data stored on the rotating optical disk is read out and is transformed by the optical disk drive, so as to produce an RF signal.

In step 23, the RF signal is input to an AGC, and a predetermined amplitude of the output RF signal is set. The gain is dynamically adjusted by the AGC correspondingly to the predetermined amplitude, and then the amplitude of the RF signal is adjusted therewith, so that the RF signal output from the AGC is within the predetermined amplitude.

In step 24, the RF signal is input to the equalizer. The equalizer is set with a parameter module of n to adjust the level of the RF signal. The n parameter module is initially determined as a normal parameter module of n=0.

In step 25, the RF signal is input to the DSP for being decoded. It is also determined in this step if the RF signal could be correctly decoded into a digital signal. If the RF signal is correctly decoded by the DSP, the next step will be proceeded since the RF signal reading and processing is correct. Otherwise, step 27 would be proceeded since the RF signal fails to be correctly read and processed.

In step 26, the decoded digital signal is output.

In step 27, the amplitude of the RF signal input to the DSP is checked, so as to determine if the amplitude of the RF signal is within a predetermined range. If the amplitude of the RF signal is not within the predetermined range, i.e. the AGC fails to normally scale the RF signal, the next step will be proceeded. If the amplitude of the RF signal is within the predetermined range, step 29 will be proceeded.

In step 28, the gain is re-adjusted by the AGC, and the method returns to step 22. In this case, the original reading speed is maintained and the steps following step 22 are repeated.

In step 29, the equalizer switches to a next parameter module of n=n+1.

In step 30, it is determined whether the value n exceeds the amount of parameter modules N that are predetermined to be applied for the same kind of optical disk. If all of the parameter modules are not applied, i.e. n<N, the method will return to step 22 where the original reading speed is maintained and the steps following step 22 are repeated. If all of the parameter modules are already applied, i.e. n>N, the next step will be proceeded.

In step 31, the reading speed of the optical disk drive is reduced since the amplitude of the RF signal is correctly adjusted by the AGC and all of the parameter modules are already applied. Accordingly, the parameter module is zero-set, i.e. n=0, to the normal one, and then the method returns to step 22. In this case, the reading speed of the optical disk drive would be reduced and then the steps following step 22 are repeated.

Through the mentioned steps of the method for signal processing in an optical disk drive according to the present invention, the regular optical disks are certainly readable under a normal operating condition, while with respect to the irregular ones, the amplitude of the output RF signal could be pre-checked and adjusted by means of the adjustment of the AGC at the highest reading speed. Therefore the irregular signals would not be output therefrom, and the reading ability of the disk drive would not be affected thereby. Moreover, by providing more than one predetermined parameter modules with respect to the respective irregular cases, the equalizer could switch to a proper parameter module thereof at the highest reading speed of the disk drive, so as to obtain a RF signal with the optimal level. In this case, the RF signal is rapidly and correctly read and decoded by the DSP, so that the performance of the optical disk drive is increasingly enhanced.

Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for signal processing in an optical disk drive, comprising steps of:
(1) reading a data on an optical disk so as to produce an RF signal with an amplitude and a level;
(2) adjusting said amplitude of RF signal with a gain;
(3) adjusting said level of RF signal with a predetermined parameter module;
(4) determining if said RF signal is readable; outputting said RF signal if it is able to be read correctly, and proceeding the next step if not; and
(5) switching to a further parameter module for serving as said predetermined parameter module, and returning to said step (1) for repeatedly performing said method.

2. The method for signal processing of claim 1, wherein in said step (1), said data is read by said optical disk drive at a predetermined highest reading speed at the start thereof.

3. The method for signal processing of claim 1, wherein in said step (2), said gain is dynamically adjusted with an automatic gain control or is fixed to a constant value, and therewith said amplitude is adjusted.

4. The method for signal processing of claim 1, wherein in said step (3), said level is adjusted by an equalizer with a parameter module thereof.

5. The method for signal processing of claim 1, wherein in said step (3), said predetermined parameter module is initially a parameter module under a normal operating condition.

6. The method for signal processing of claim 1, wherein in said step (4), said RF signal is input to a digital signal processor and decoded thereby, wherein said RF signal is determined as readable if it is correctly decoded.

7. The method for signal processing of claim 1, wherein said optical disk drive is provided with a plurality of parameter modules with respect to said optical disk of a same kind for being switched in said step (5).

8. The method for signal processing of claim 7, wherein each of said plurality of parameter modules corresponds to respective operating conditions.

9. The method for signal processing of claim 8, wherein said respective operating conditions are one selected from a group consisting of said optical disk being of a relatively worse property, said optical disk being of a relatively higher or lower asymmetry, and said optical disk being jittering.

10. The method for signal processing of claim 7, wherein said step (5) further comprises a step of determining if all of said plurality of parameter modules are switched for serving as said predetermined parameter module; if not, returning to said step (1) for repeatedly performing said method, and if yes, reducing said reading speed, zero-setting said parameter module and returning to said step (1) for repeatedly performing said method.

11. The method for signal processing of claim 7, wherein in said step (5), said plurality of parameter modules are switched in turns until a proper parameter module is selected therefrom for adjusting said level of RF signal.

12. The method for signal processing of claim 1, wherein after said step (4) further comprising a step of:
(4-1) determining if said amplitude of RF signal is within a predetermined range; if not, adjusting said gain and returning to said step (1) for repeatedly performing said method, and if yes, proceeding said step (5).

13. A method for signal processing in an optical disk drive, comprising steps of:
i. said optical disk drive reading a data on an optical disk at a reading speed thereof to produce an RF signal with an amplitude and a level;
ii. adjusting said amplitude of RF signal with a gain;
iii. adjusting said level of RF signal with a predetermined parameter module;
iv. determining if said RF signal is readable; outputting said RF signal if it is able to be read correctly, and proceeding the next step if not;
v. determining if said amplitude of RF signal is within a predetermined range; if not, adjusting said gain and returning to said step (1) for repeatedly performing said method, and if yes, proceeding the next step; and
vi. reducing said reading speed and returning to said step (1) for repeatedly performing said method.

14. The method for signal processing of claim 13, wherein in said step (1), said data is read by said optical disk drive at a predetermined highest reading speed at the start thereof.

15. The method for signal processing of claim 13, wherein in said step (2), said gain is dynamically adjusted with an automatic gain control or is fixed to a constant value, and therewith said amplitude is adjusted.
